(19) United States
(12) Patent Application Publication
(10) Pub. No.: US 2022/0165145 A1
(43) Pub. Date: May 26, 2022

(54) ELECTRONIC TILT SENSING, TRACKING, AND REPORTING SYSTEM

(71) Applicant: SIMTEC, INC, Las Vegas, NV (US)

(72) Inventors: Dennis Colonello, Los Angeles, CA (US); James E. Grove, Marina Del Rey, CA (US); Bradley Abbott, Crowley, TX (US)

(21) Appl. No.: 17/533,818

(22) Filed: Nov. 23, 2021

Related U.S. Application Data
(60) Provisional application No. 63/118,430, filed on Nov. 25, 2020.

(51) Int. Cl. G08B 21/04; G01D 11/30; G01C 9/06

(52) U.S. Cl. CPC G08B 21/0461; G01C 9/06; G01D 11/30

(57) ABSTRACT

An electronic tilt sensing, tracking, and reporting system for monitoring a posture or a movement of a user seated in a chair. The system includes a mount adapted for attachment to the chair, and a sensor portion removeably secured to the mount. The sensor portion includes a sensing assembly that is adapted to sense an orientation of part of the chair relative to the ground on which the chair is supported to determine the posture or the movement of the user seated in the chair.

### CROSS-REFERENCE TO RELATED APPLICATION

This application claims the benefit of U.S. Provisional Patent Application No. 63/118,430, filed on Nov. 25, 2020, the disclosure of which is incorporated by reference herein in its entirety.

### FIELD OF INVENTION

The present disclosure relates to a sensing system for a chair. More particularly, the present disclosure relates to an electronic tilt sensing, tracking, and reporting system adapted for use with a chair having a posture-improving seat cradle.

### BACKGROUND

Neutral spine posture is considered by experts in the field of ergonomics to be the preferred sitting posture. Anatomically, neutral spine posture is defined as the spinal curvature wherein the cervical and lumbar divisions of the spine are moderately convex anteriorly (lordosis) and the thoracic and sacral divisions of the spine are moderately convex posteriorly (kyphosis).

Many experts working in the field of ergonomics agree that neutral spine posture is facilitated by promoting both anterior pelvic tilt and lumbar lordosis. Traction of the spine has long been generally accepted as an effective method for alleviating back pain. Traction of the spine unloads the soft and hard tissue structures of the spine thereby relieving these tissues from the compressive forces associated with prolonged sitting, which may relieve the pain associated therewith.

Several chair designs have been proposed to improve the posture of an occupant. One such example is disclosed in U.S. Pat. No. 10,314,400, the entirety of which is herein incorporated by reference. In one embodiment, the chair includes a seat cradle that is rotatable, thereby promoting dynamic anterior pelvic tilt and dynamic lumber lordosis while simultaneously unloading the user's upper body weight from his or her pelvis. This effectively positions the user's back towards a neutral spine seated posture.

Other posture improving chairs are known in the art. It is desired to track the activity of the user while seated in a posture improving chair as a proxy for monitoring the user's posture or movement.

### SUMMARY OF THE INVENTION

In one embodiment, an electronic tilt sensing, tracking, and reporting system for monitoring a posture or a movement of a user seated in a chair includes a mount adapted for attachment to the chair. A sensor portion is removeably secured to the mount. The sensor portion includes a sensing assembly that is adapted to sense an orientation of part of the chair relative to the ground on which the chair is supported to determine the posture or the movement of the user seated in the chair.

In another embodiment, a method of monitoring a posture or a movement of a user seated in a chair includes the steps of providing an electronic tilt sensing, tracking, and reporting system that includes a mount and a sensor portion. The sensor portion includes a sensing assembly and a feedback device. The method further includes attaching the mount to part of the chair and securing the sensor portion to the mount. An orientation of part of the chair relative to the ground on which the chair is supported is sensed using the sensing assembly. The posture or movement of the user seated in the chair is determined based on the step of sensing an orientation of part of the chair. Feedback is provided to the user using the feedback device. The feedback is regarding the posture or movement.

In yet another embodiment, an electronic tilt sensing, tracking, and reporting system for monitoring a posture or a movement of a user seated in a chair includes mount adapted for attachment to the chair. The mount including a first magnet. A sensor portion includes a second magnet. The second magnet interacts with the first magnet to removeably secure the sensor portion to the mount. The sensor portion further includes a sensing assembly and a lighting arrangement. The lighting arrangement provides visual feedback to the user regarding posture or movement of the user based on an orientation of part of the chair relative to the ground on which the chair is supported. The orientation is determined by the sensing assembly.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of one embodiment of an electronic tilt sensing, tracking, and reporting system;

FIG. 2 is a side view of the system of FIG. 1;

FIG. 3 is a schematic view of electronics and working components of the system of FIG. 1;

FIG. 4 is an exploded view of the system of FIG. 1 shown in relation to a chair to which the system may be attached;

FIG. 5 is an additional view of FIG. 4 showing an intermediate step of attaching the system to the chair;

FIG. 6 is an additional view of FIG. 4 showing the system attached to the chair;

FIG. 7 is alternative perspective view of FIG. 6 showing the system attached to the chair;

FIG. 8 is a side view of FIG. 6 showing the system attached to the chair;

FIG. 9 is a front view of FIG. 6 showing the system attached to the chair;

FIG. 10 is a flow chart showing a process of attaching the system to the chair;

FIG. 11 is an exploded perspective view of another embodiment of an electronic tilt sensing, tracking, and reporting system;

FIG. 12 is a bottom perspective view of part of the system of FIG. 11

FIG. 13 is a side view of the assembled system of FIG. 11;

FIG. 14 is a sectional view of the system as shown in FIG. 13;

FIG. 15 is a side view of the system of FIG. 11 attached to part of a chair;

FIG. 16 is an elevated side view of a base configured to be used with the system of FIG. 11;

FIG. 17 is an exploded perspective view showing part of the system of FIG. 11 in relation to the base of FIG. 16; and

FIG. 18 is a plan view of a lighting arrangement that may be used with the system of FIG. 1 or the system of FIG. 11.

### DETAILED DESCRIPTION

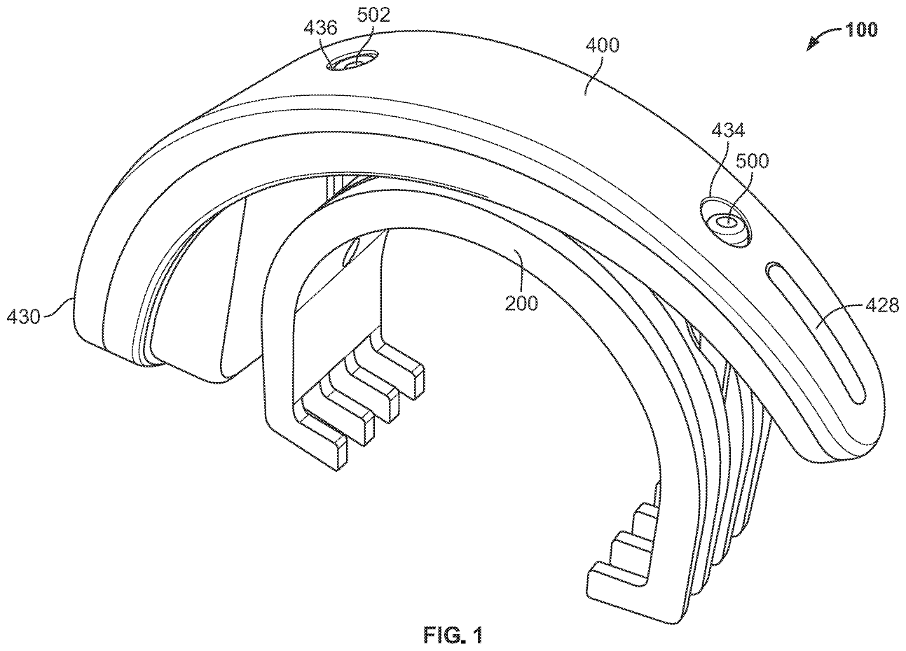

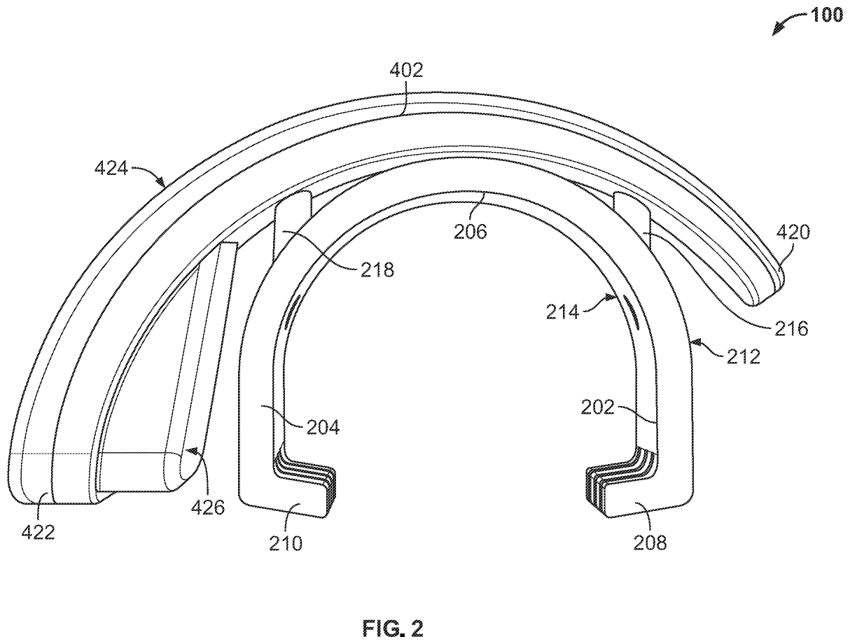

FIGS. 1 and 2 show one embodiment of a tilt sensing, tracking, and reporting system 100. The system 100 may be used with a chair having a posture-improving seat cradle. The system 100 includes a mount 200 and a sensor portion 400.

The mount 200 incudes a first arm portion 202 and a second arm portion 204. The first and second arm portions 202, 204 extend substantially parallel to one another. An arcuate portion 206 extends between and interconnects the first arm portion 202 and the second arm portion 204. Together, the first and second arm portions 202, 204 and the arcuate portion 206 form a U-shape. The first and second arm portions 202, 204 are resilient members that can flex to move relative to the arcuate portion 206. While the first and second arm portions 202, 204 are shown as being substantially linear, it should be understood that non-linear arm portions may be employed. For example, the arm portions may be curved or may include multiple portions.

First retaining fingers 208 extend inwardly from the first arm portion 202 at an obtuse angle. Second retaining fingers 210 extend inwardly from the second arm portion 204 at an obtuse angle. The first and second retaining fingers 208, 210 extend toward one another and substantially transverse to the first and second arm portions 202, 204, respectively. In an alternative embodiment (not shown), the first and second retaining fingers 208, 210 each extend at a right angle from the first and second arm portions 202, 204, respectively. In another alternative embodiment (not shown), the first and second retaining fingers 208, 210 each extend at an acute angle from the first and second arm portions 202, 204, respectively. In other alternative embodiments the retaining fingers are omitted.

The mount 200 further includes a first face 212 and a second face 214. The first and second retaining fingers 208, 210 extend from the second face 214. First and second fastener receiving extensions 216, 218 extend from the first face 212. The first fastener receiving extension 216 is provided at the approximate junction between the first arm portion 202 and the arcuate portion 206. The second fastener receiving extension 218 is provided at the approximate junction between the second arm portion 204 and the arcuate portion 206. The first and second fastener receiving extensions 216, 218 extend substantially parallel with one another and parallel to the first and second arm portions 202, 204. In alternative embodiments, the fastener receiving extensions may be provided at any desired location on the mount or have any desired relative orientation.

The sensor portion 400 includes a housing 402. In one example embodiment the housing 400 is composed of two or more discrete components that utilize snap connections to form a water-tight compartment. In an alternative embodiment, the housing 400 may be composed of two or more discrete components that are secured together by any desired arrangement such as mechanical fasteners or adhesives. In another alternative embodiment, the housing 402 may be of a unitary construction. The housing 402 includes a first face 424 and a second face 426. A first fastener aperture 434 and a second fastener aperture 436 each extend through the housing 402 from the first face 424 to the second face 426.

As shown in FIG. 1, when the system 100 is attached to the chair, a first fastener 500 is received in the first fastener aperture 434 at the first face 424 and extends through the housing 402 to extend from the second face 426. A second fastener 402 is received in the second fastener aperture 436 at the first face 424 and extends through the housing 402 to extend from the second face 426. In one example embodiment the fasteners 500, 502 are screws. In alternative embodiments the first and second fasteners may be bolts, pins, or any desired fastener.

The portion of the first fastener 500 and second faster 502 that extends from the second face 426 is received in the first fastener extension 216 and the second fastener extension 218, respectively, to attach the sensor portion 400 to the mount 200. When the sensor portion 400 is attached to the mount 200, the first end 420 of the housing 402 is located adjacent the first arm portion 202 of the mount 200, the second end 422 of the housing 402 is located adjacent the second arm portion 204 of the mount 200, and the second face 426 of the housing 402 faces the first face 212 of the mount 200.

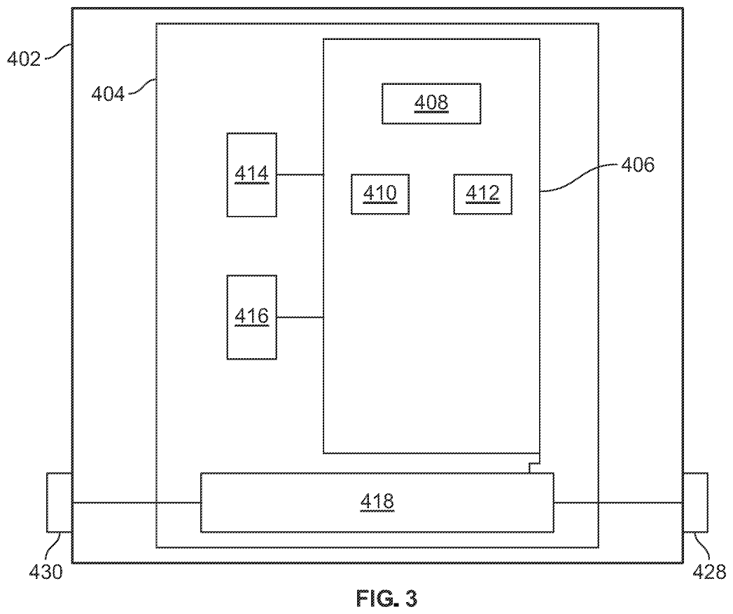

FIG. 3 illustrates a schematic view of electronics and working components of the system of FIG. 1. As can be seen from this view, the housing 402 houses a sensing assembly 404. In the illustrated embodiment, the sensing assembly 404 includes a printed circuit board 406, a microcontroller 408, a tilt sensor 410, a memory 412, a transmitter and receiver 414, a feedback generator 416, and a power supply 418.

In one embodiment, the microcontroller 408 controls the overall operation of the system 100. The tilt sensor 410 provides information that enables the microcontroller 408 to determine information (e.g., orientation of the chair relative to an underlying surface) about the chair to which the system 100 is attached. In one example embodiment, the tilt sensor 410 senses an orientation of part of the chair relative to the ground on which the chair is supported. The microcontroller 408 can interpret this information to determine the posture or movement of the user seated in the chair. The memory 412 stores instructions for operation of the system 100 or stores information about the chair (e.g., data log tracking orientation of the chair as a function of time).

In one embodiment the transmitter and receiver 414 is a wireless arrangement allows the system 100 to pair with an external operating device. In one example embodiment, the external operating device is a cellular phone and the transmitter and receiver 414 is a Bluetooth unit. In alternative embodiments, the external operating device may be any desired device (e.g., tablet, laptop computer, smart watch, other wearable device, etc.) and the transmitter and receiver may be any desired arrangement. When paired with an external operating device, the transmitter and receiver 414 can send information from the system 100 to the external operating device regarding real-time information about the orientation or movement of the chair or stored information relating to the same accessed from the memory 412. Additionally, the transmitter and receiver 414 can receive information from the external operating device (e.g., software updates for the system 100). An application may be installed on the memory 412 of the system 100 or the external operating device to facilitate transmission of information therebetween via the transmitter and receiver 414.

The feedback generator 416 is configured to provide feedback to the user regarding orientation of the chair. In one example embodiment, the feedback generator 416 is a haptic feedback generator that vibrates. The feedback generator 416 may provide feedback when the system 100 senses that the chair is at an undesirable orientation. Alternatively, the feedback generator 416 may be configured to provide feedback when the system 100 senses that the chair is at a desirable orientation. In an alternative embodiment, the feedback generator 416 is a light or a plurality of lights that flash in certain patterns or change colors to provide feedback. The feedback generator 416 may also, or alternatively, provide feedback that indicates to the user that that the chair is exhibit a desirable or undesirable level of movement. The feedback generator 416 may also be configured to indicate that the transmitter and receiver 414 has successfully connected to an external operating device.

The power supply 418 provides power for any one or more of the components of the system 100. In one example embodiment power is drawn from the power supply 418 only when the system 100 senses that the chair is occupied. Alternatively, a switch may be provided that allows a user to select when power is drawn from the power supply (i.e., turn the system on or off).

In alternative embodiments the printed circuit board, microcontroller, tilt sensor, memory, transmitter and receiver, feedback generator, or power supply may be provided with any desired functionality. In other alternative embodiments, the sensing assembly may omit any one or more of the foregoing components or may include additional components.

The housing 402 is substantially arcuate and extends between a first end 420 and a second end 422. As described above, the housing 402 includes a first face 424 and a second face 426. A light 428 may be provided on the first face 424 toward the first end 420. In one example embodiment the light 428 is configured to illuminate a solid color when the system 100 is powered on or flash when the transmitter and receiver 414 of the sensing assembly 404 is connecting with an external operating device. In an alternative embodiment the light may be adapted to provide a visual indication about any operational status of the system by, for example, changing colors. In another alternative embodiment, the light may be omitted and the functionality of the light may be incorporated into the feedback generator.

A connection port 430 is provided on the first face 424 toward the second end 422. In one example embodiment the connection port 430 is a universal serial bus (USB) port. In an alternative embodiment the connection port may be any desired port. The connection port 430 is configured to recharge the power supply 418, or transfer data from the microcontroller 408 or memory 412 to an external unit. In alternative embodiments the connection port may be provided with any desired functionality. In other alternative embodiments the connection port may be omitted from the housing.

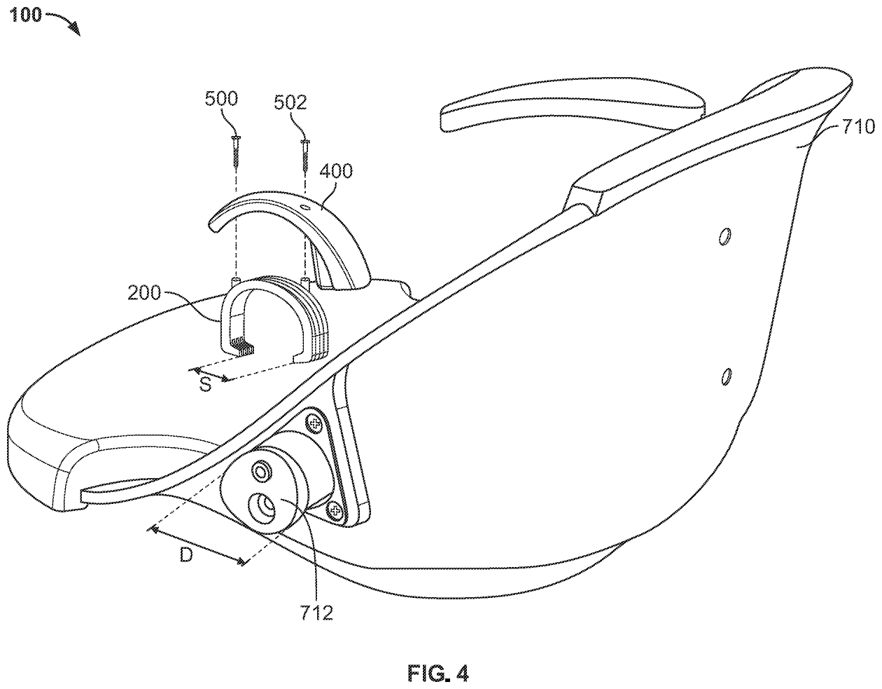

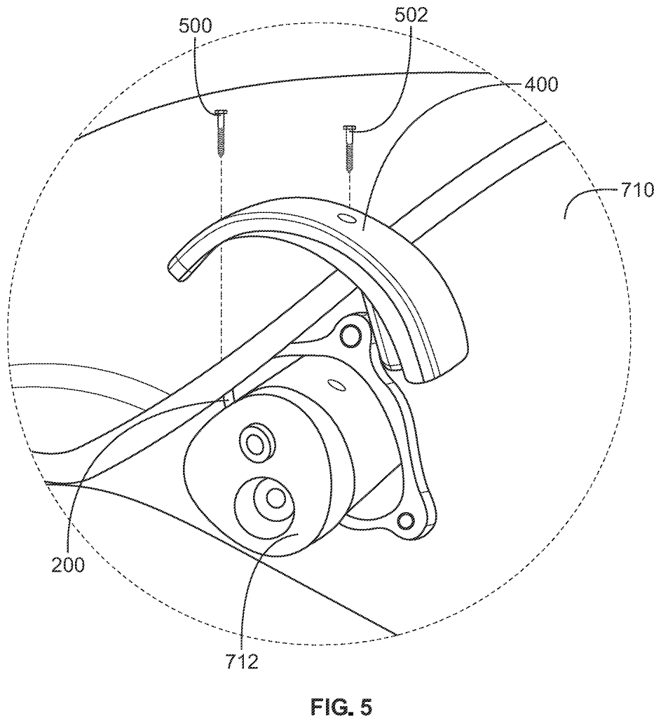

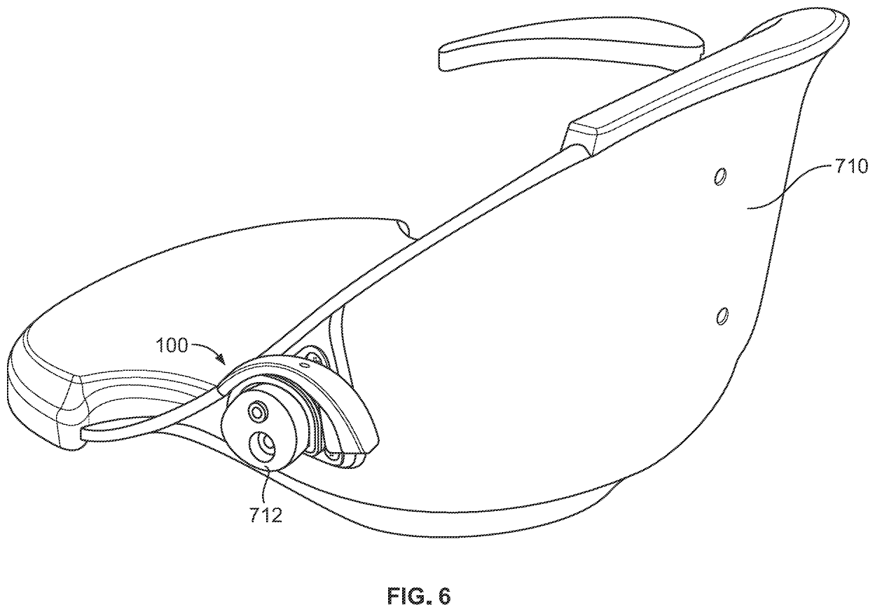

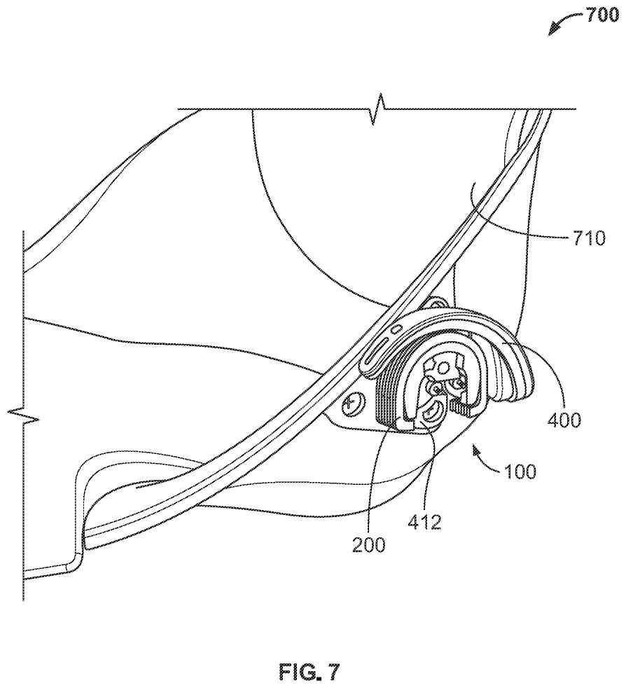

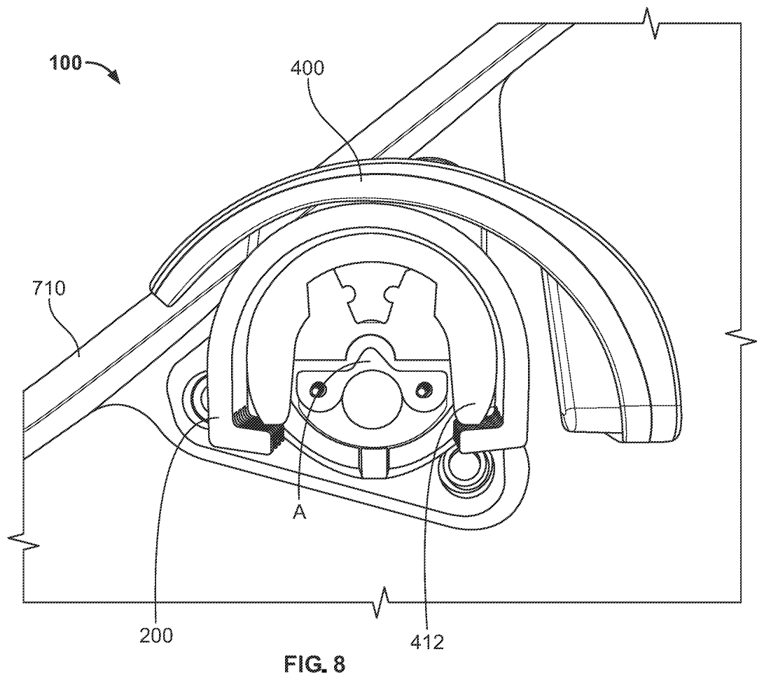

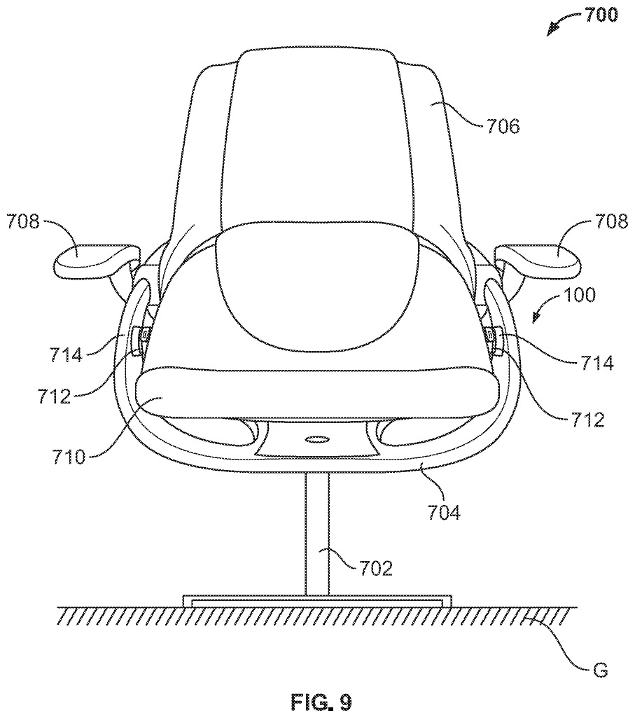

Referring to FIGS. 4-9, an exemplary chair 700 to which the system 100 may be attached is shown. The chair includes a base 702 that is configured to be supported by the ground (G). The base 702 supports a yoke 704. A back 706 and arm pads 708 are fixedly attached to the yoke 704. The chair 700 further includes a cradle 710. The cradle 710 includes support bushings 712. The support bushings 712 are received in coupling holes 714 provided on the yoke 704 to pivotally attach the cradle 710 to the yoke 704. The cradle 710 is pivotable relative to the yoke 704 about a rotation axis (A). When a user sits in the chair 700, the lumbar, sacral, gluteal, and femoral regions of the user are supported by the cradle 710, while the lumbar and vertebral regions of the user are supported by the back 706. While sitting in the chair, the user may pivot the cradle 710 relative to the yoke 704 and the back 706 about the rotation axis (A) to position the cradle 710 at a desired orientation.

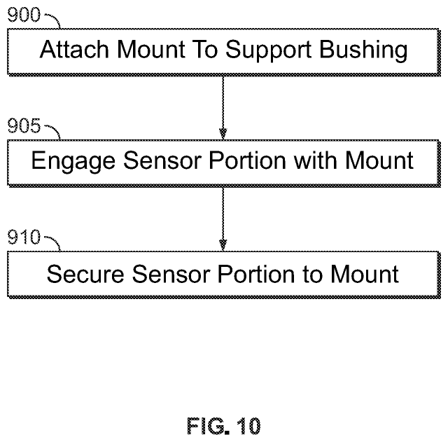

Referring to FIG. 10 and with continued reference to FIGS. 4-9, an exemplary method of attaching the system 100 to the chair 700 is described. At 900, the mount 200 is attached to one of the support bushings 712 with the second arm portion 204 being positioned closer to the back 706 of the chair 700 than the first arm portion 202. To attach the mount 200 to the support bushing 712, the resilient first and second arm portions 202, 204 are forced away from one another from an initial position to a spread position such that a space (S) between the first and second retaining fingers 208, 210 is greater than the a diameter (D) of the support bushing 712. While maintain the spread position, the mount 200 is placed around the support bushing 712 such that the second face 214 of the mount 200 is in contact with the support bushing 712 and the first and second retaining fingers 208, 212 are substantially parallel to the ground on which the chair 700 is supported. Upon such placement, the first and second arm portions 202, 204 are released, thereby allowing the first and second arm portions 202, 204 to move from the spread position back to the initial position. In the initial position, an interference fit is formed between the mount 200 and the support bushing 712 such that the mount 200 cannot move relative to the support bushing 712. In other words, the mount 200 is secured for rotation with the support bushing 712. Additionally, in this initial position, the first and second retaining fingers 208, 210 engage with the support bushing 712, thereby further securing the mount 200 to the support bushing 712.

At 905 the sensor portion 400 is engaged with the mount 200. To engage the sensor portion 400 with the mount 200, the second face 426 of the housing 402 is presented toward the first face 212 of the mount 200, and the first and second fastener apertures 434, 436 are aligned with the first and second fastener receiving extensions 216, 218, respectively. While maintaining this presentation and alignment, the sensor portion 400 is advanced toward the mount 200 until the first and second fastener receiving extensions 216, 218 contact the second face 426 of the housing 402. In this position, the first end 420 of the housing 402 is located adjacent the first arm portion 202 of the mount 200, the second end 422 of the housing 402 is located adjacent the second arm portion 204 of the mount 200, and a portion of the second face 426 of the housing 402 may be in engagement with a portion of the first face 212 of the mount 200.

At 910 the sensor portion 400 is secured to the mount 200. To secure the sensor portion 400 to the mount 200, the first and second fasteners 500, 502 are inserted into the first and second fastener apertures 434, 436, respectively. The first and second fasteners 500, 502 pass through the housing 402 via the first and second apertures 434, 436, respectively, and into the first and second fastener receiving extensions 216, 218, respectively. The first and second fasteners 500, 502 are then tightened, at which point the process of attaching the system 100 to the chair 700 is complete.

While the system 100 has been described as being attached to the above described chair 700, the system 100 may be attached to any desired chair design. Additionally, the system 100 may be attached to any chair using any desired method beyond the one described above.

In use, due to the above described connection between the system 100 and the chair 700, the system 100 will pivot with the cradle 710 about the rotation axis (A) as a user sits in the chair and pivots the cradle 710 relative to the yoke 704 and the back 706. The sensing assembly 404 interprets this movement to assess the orientation of the cradle 710 and provide feedback to the user. For example, the sensing assembly 404 may provide feedback via the feedback generator 416 when the orientation of the cradle 710 indicates that the user's posture is improper. As another example, the sensing assembly 404 may track the orientation of the cradle 710 over a specified time period and generate a report that tracks the user's posture or movement as a function of time. The report may be displayed via a graphic interface that is part of an external operating device application. As yet another example, the sensing assembly 404 may be provided with “exercise mode” software, wherein the user is directed, using haptic feedback, visual feedback, or notification via an application on an external operating device, to change the orientation of the cradle 710 in rapid succession. As still yet another example, a user may option to keep any data collected by the system 100 private, or may choose to share data collected by the system 100 with a network that allows one user to compare his or her posture or movement with other users. As yet even a further example, when a user chooses to share data with the network, the user may engage in a “game mode” wherein movements of users are compared against one another and scored in a competition or displayed on leaderboards.

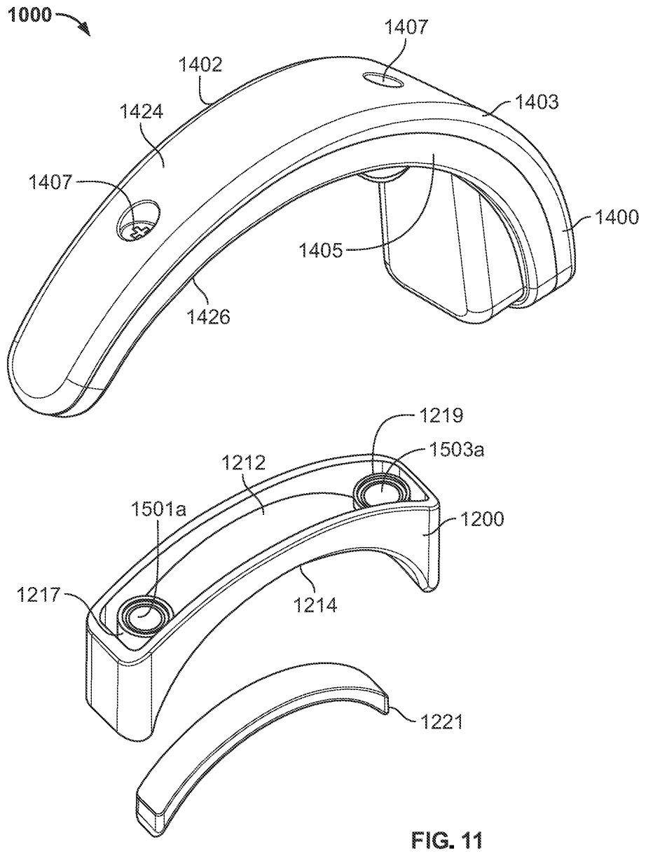

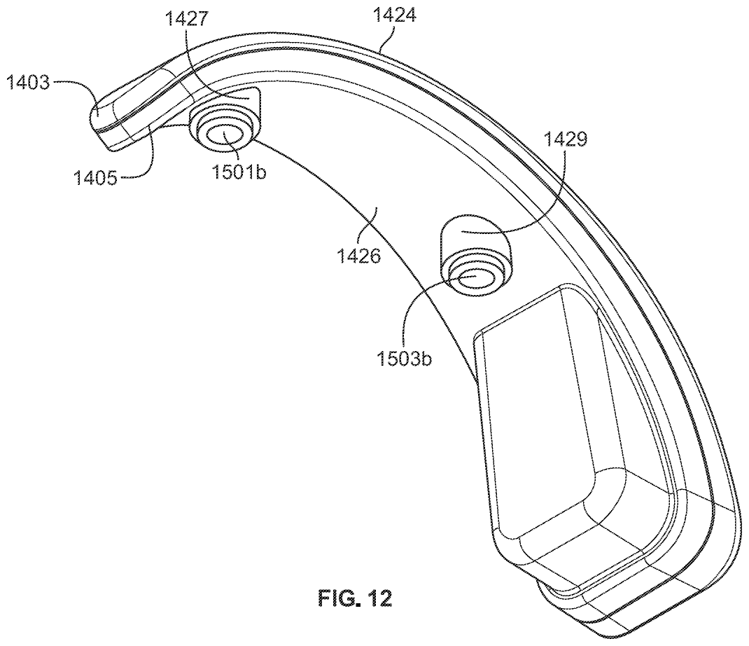

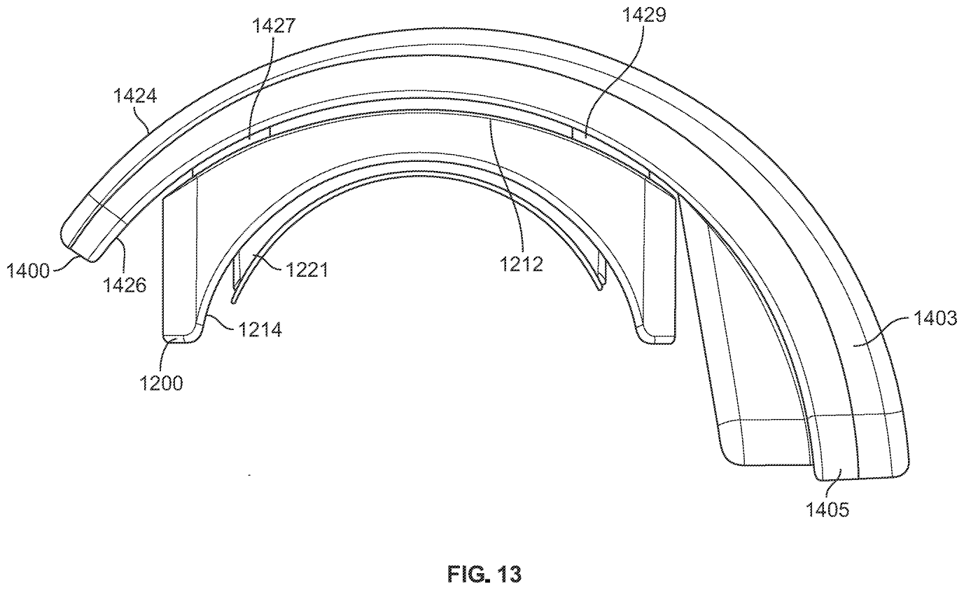

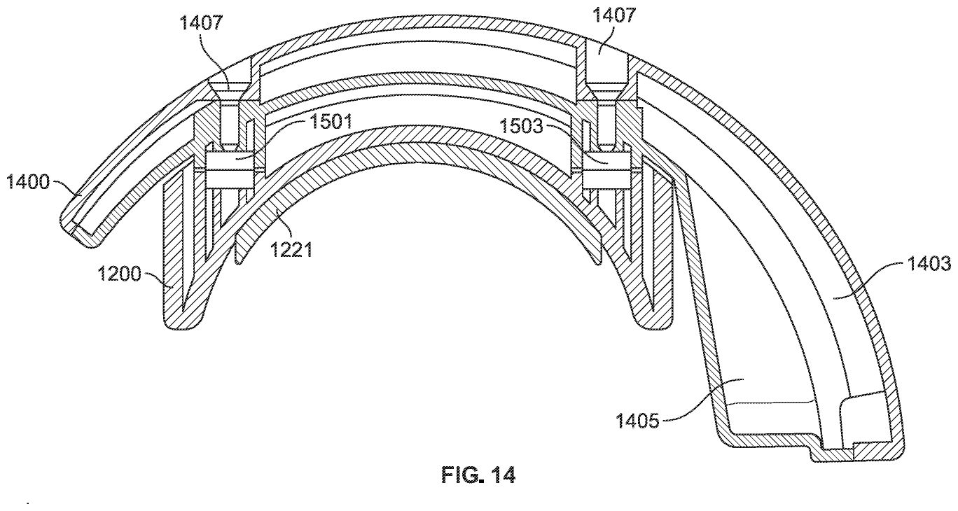

FIGS. 11-14 show another embodiment of a tilt sensing, tracking, and reporting system 1000. The system 1000 of this embodiment is substantially similar to the system 100 described above in reference to FIGS. 1-10 except for the differences described herein. Like features shared between the system 1000 of FIGS. 11-14 and the system 100 described in reference to FIGS. 1-10 will be identified by like numerals increased by a value of “1000.” Any alternative embodiments of the system 100 described in reference to FIGS. 1-10 may be applicable to the system 1000 of FIGS. 11-14, and any of the alternative embodiments of the system 1000 of FIGS. 11-14 may be applicable to the system 100 described in reference to FIGS. 1-10.

The system 1000 includes a mount 1200 and a sensor portion 1400. A first attachment mechanism 1501 and a second attachment mechanism 1503 are provided for attaching the sensor portion 1400 to the mount 1200. In one example embodiment each of the first and second attachment mechanisms 1501, 1503 is a pair of magnets. In alternative embodiments the first and second attachment mechanisms may be fasteners such as screws and threaded openings, hook-and-loop fasteners, or any other desired arrangement.

The mount 1200 includes a first face 1212 and a second face 1214. First and second mount attachment receiving extensions 1217, 1219 extend from the first face 1212. The first mount attachment receiving extension 1217 receives a first part 1501a of the first attachment mechanism 1501, and the second mount attachment receiving extension 1219 receives a first part 1503a of the second attachment mechanism 1503. In alternative embodiments, the mount attachment receiving sections may be omitted, and the attachment mechanisms may be received in the body of the mount.

The sensor portion 1400 includes a housing 1402. The housing 1402 includes a first part 1403 and a second part 1405. In one example embodiment, mechanical fasteners 1407 fasten the first part 1403 and the second part 1405 together. In an alternative embodiment the first part and the second part may be fastened using any desired arrangement, such as snap connections or adhesive. In other alternative embodiments, the sensor portion may have a unitary construction.

The housing 1402 includes a first face 1424 provided on the first part 1403 and a second face 1426 provided on the second part 1405. First and second housing attachment receiving extensions 1427, 1429 extend from the second face 1426. The first housing attachment receiving extension 1427 receives a second part 1501b of the first attachment mechanism 1501, and the second housing attachment receiving extension 1429 receives a second part 1503b of the second attachment mechanism 1503. The spacing between the first and second housing attachment receiving extensions 1427, 1429 corresponds to the spacing between the first and second mount attachment receiving extensions 1217, 1219. Consequently, when the sensor portion 1400 is attached to the mount 1200, the first and second parts 1501a, 1501b of the first attachment mechanism are aligned with one another, and the first and second parts 1503a, 1503b of the second attachment mechanism 1503 are aligned with one another. In alternative embodiments, the housing attachment receiving sections may be omitted, and the attachment mechanisms may be received in the body of the housing.

The housing 1402 houses a sensing assembly (not shown), which may include a printed circuit board, a microcontroller, a tilt sensor, a memory, a transmitter and receiver, a feedback generator, and a power supply. Additionally, the housing 1402 is provided with a light (not shown) and a connection port (not shown). In one example embodiment the first part 1403 of the housing 1402 is translucent and the light is configured to illuminate at least portion of the first part 1403 of the housing 1402. In an alternative embodiment the first part of the housing is opaque and the light is visible through an aperture provide on the housing or the light is provided on an exterior surface of the housing.

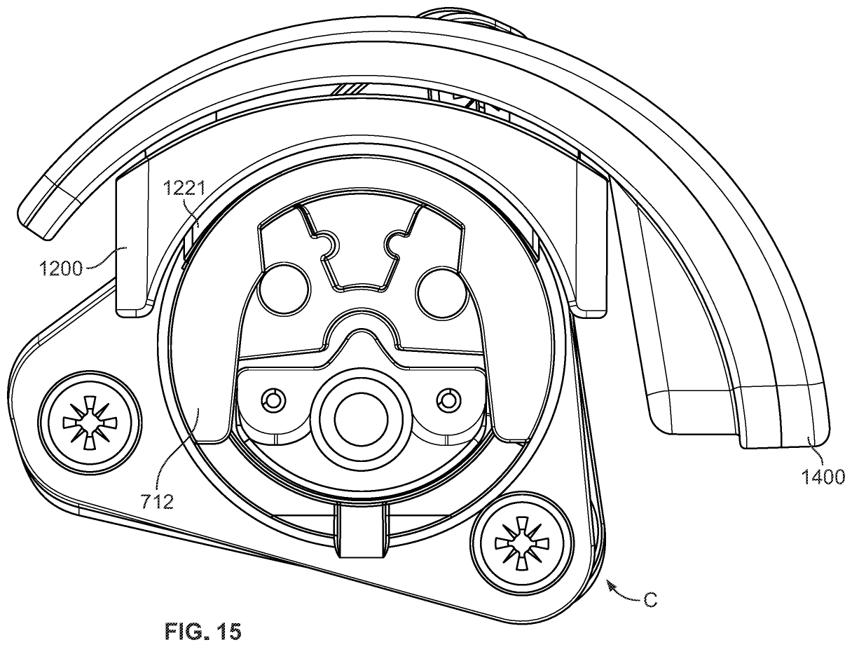

Referring to FIG. 15 and with continued reference to FIGS. 11-14, an exemplary process of attaching the system 1000 to a component (C) of a chair will now be described. As it relates to this description, the component (C) to which the system 1000 can be attached may be part of a chair that is substantially identical to the chair 700 used with the system 100 described above in reference to FIGS. 1-10. It should be understood, however, that the system 1000 may be attached to any chair.

First, the mount 1200 is attached to one of the support bushings 712 such that the second mount attachment receiving extension 1219 is closer to the back 706 of the chair 700 than the first mount attachment receiving extension 1217. In one example embodiment, the mount 1200 is attached to the support bushing 712 using adhesive 1221 (e.g., double sided tape) that secures the second face 1214 of the mount 1200 to an exterior surface of the support bushing 712. In alternative embodiments the mount may be attached to the support bushing using any desired arrangement such as adhesives or mechanical fasteners.

Next, the sensor portion 1400 is secured to the mount 1200. To secure the sensor portion 1400 to the mount 1200 the second face 1426 of the housing 1402 is presented toward the first face 1212 of the mount 1200, and the first and second housing attachment receiving extensions 1427, 1429 are aligned with the first and second mount receiving extensions 1217, 1219. While maintaining this presentation and alignment, the sensor portion 1400 is advanced toward the mount 1200 until the first and second parts 1501a, 1501b of the first attachment mechanism 1501 engage one another and the first and second parts 1503a, 1503b of the second attachment mechanism 1503 engage one another. The process of attaching the system 1000 to the chair 700 is then complete. The magnetic force of the magnets of the first and second attachment mechanisms 1501, 1503 retains the sensor portion 1400 on the mount 1200.

In an alternative embodiment, the first and second parts of the first attachment mechanism or the first and second parts of the second attachment mechanism may be arranged such that the magnets do not engage one another. According to this embodiment. although the magnets are not in engagement, the sensor portion is still retained on the mount by virtue of the magnetic force of the magnets.

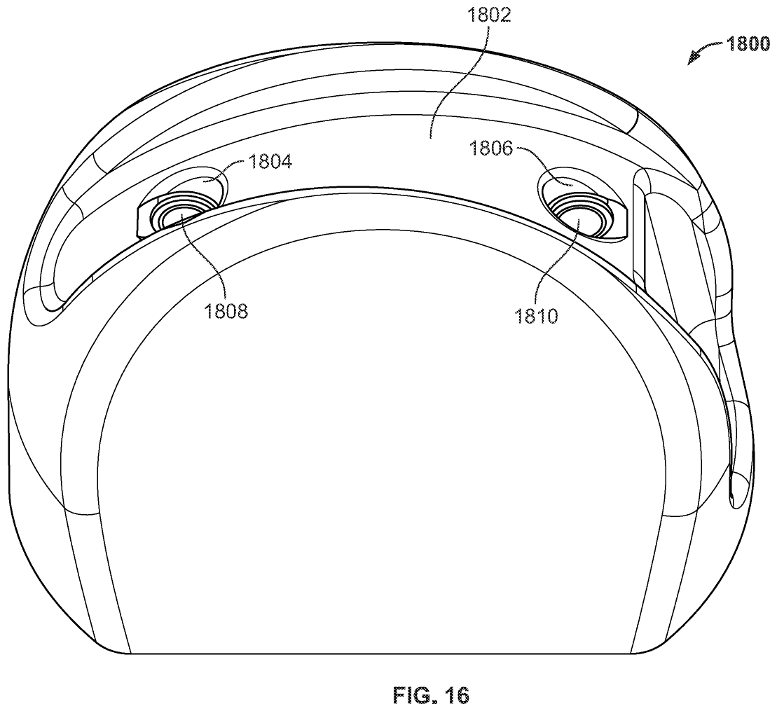

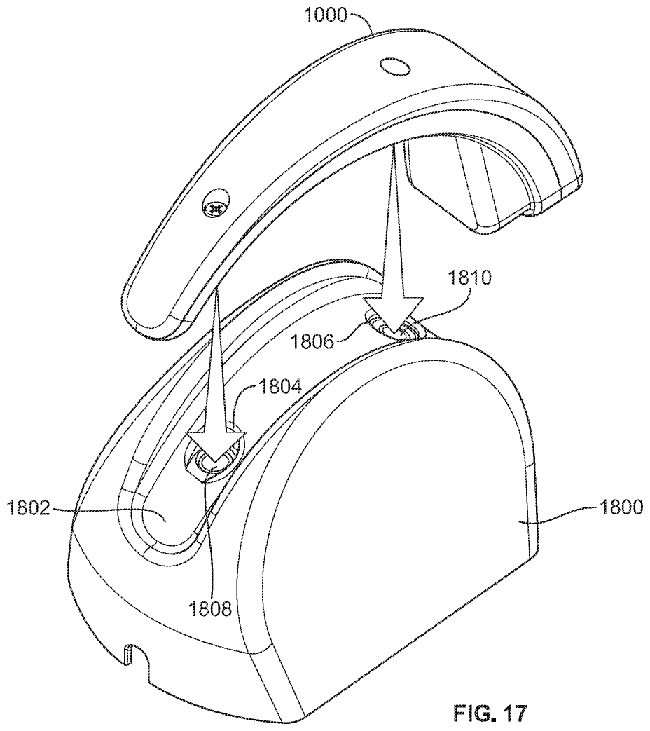

Referring to FIGS. 16 and 17, the system 1000 may be provided with a base 1800. In one example embodiment the base 1800 is configured to provide power to recharge the power supply of the sensor portion. In an alternative embodiment the base may be configured to provide any desired functionality in relation to the sensor portion. For example, the base may be configured to receive data from, or transmit data to, the memory of the sensor portion.

A concavity 1802 is provided on an upper portion of the base 1800. The concavity is dimensioned and configured to receive the second part 1405 of the housing 1402 of the sensor portion 1400. In other words, the concavity 1802 approximates a negative impression of the second part 1405 of the housing 1402.

A first recess 1804 and a second recess 1806 are provided in the concavity 1802. First and second contacts 1808, 1810 are provided in the first and second recesses 1804, 1806, respectively. In one example embodiment the first and second contacts 1808, 1810 are configured to interact with contacts (not shown) provided in the first and second housing attachment receiving extensions 1427, 1429, respectively, to transmit power to the sensor portion 1400 and recharge the power supply. In alternative embodiments the contacts may be configured with any desired functionality. For example, the contacts may be configured for the transmission of data.

The base 1800 may be provided with a cord (not shown). In one example embodiment the cord is configured to transmit power. In alternative embodiments, the cord may be configured with any desired functionality. For example, the cord may be configured to transmit data.

A process of using the base 1800 with the sensor portion 1400 will now be explained. First, the second face 1426 of the housing 1402 is presented toward the concavity 1802 of the base 1800, and the first and second housing attachment receiving extensions 1427, 1429 are aligned with the first and second recesses 1804, 1806, respectively. While maintaining this presentation and alignment, the sensor portion 1400 is advanced toward the mount base 1800 until the first and second housing attachment receiving extensions 1427, 1429 are received in the first and second recesses 1804, 1806, respectively. The sensor portion 1400 may then be released, at which point the housing 1402 is retained by the concavity 1802 and the contacts of the sensor portion 1400 are in communication with the first and second contacts 1808, 1810 of the base 1800. In one example embodiment the communication is established by way of physical engagement between the contacts of the sensor portion 1400 and the first and second contacts 1808, 1810 of the base 1800. In an alternative embodiment communication between the contacts of the sensor portion and the first and second contacts of the base may be established without physical engagement (i.e., wirelessly).

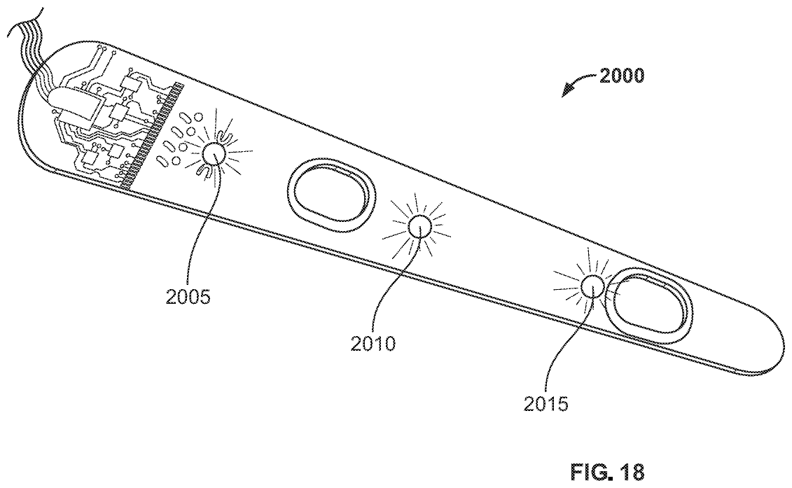

FIG. 18 shows an exemplary lighting arrangement 2000 that may be used with the system 100 described in reference to FIGS. 1-10 or the system 1000 described in reference to FIGS. 11-14. The lighting arrangement 2000 may act as the feedback generator 416. In the illustrated embodiment, the lighting arrangement includes three light sources 2005, 2010, 2015 that are arranged in a line. The light sources 2005, 2010, 2015 are capable of displaying at least two different colors. The microcontroller 408 is configured to control the color of the light sources 2005, 2010, 2015 to indicate a status of the chair or a posture or movement of an occupant seated in the chair. According to one example embodiment, the light sources 2005, 2010, 2015 are red when the microcontroller 408 determines that the orientation of the chair corresponds to undesirable posture and green when the orientation of the chair corresponds to desirable posture. In alternative embodiments, the lighting arrangement may include a fewer or greater number of light sources, and the light sources may be provided in any desired arrangement. In other alternative embodiments, the light sources may be configured to display a fewer or greater number of colors, or may be configured to flash, illuminate sequentially (i.e., only one light source is illuminated, then two light sources, then all three), or illuminate selectively (i.e., only the middle light source is illuminated or only the outer two light sources are illuminated). In still other alternative embodiments, the light sources may be configured with any desired functionality. For example, the light sources may be configured to display a certain color to signal to an occupant that he or she should engage in an “exercise mode” as described above.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described.

Accordingly, departures may be made from such details without departing from the spirit or scope of the applicant's general inventive concept.

What is claimed is:

1. An electronic tilt sensing, tracking, and reporting system for monitoring a posture or a movement of a user seated in a chair, the system comprising:
a mount adapted for attachment to the chair; and
a sensor portion removeably secured to the mount, the sensor portion including a sensing assembly that is adapted to sense an orientation of part of the chair relative to the ground on which the chair is supported to determine the posture or the movement of the user seated in the chair.

2. The system of claim 1 further comprising fasteners that secure the sensor portion to the mount.

3. The system of claim 1 further comprising magnets that secure the sensor portion to the mount.

4. The system of claim 1, wherein the mount includes resilient arm portions that engage with part of the chair to attach the mount to the chair.

5. The system of claim 4, wherein the mount includes fingers that extend from the resilient arm portions, the fingers engaging with part of the chair to retain the mount on the chair.

6. The system of claim 1 further comprising an adhesive that attaches the mount to the chair.

7. The system of claim 1, wherein the sensor portion includes a haptic feedback device that provides haptic feedback to the user regarding posture or movement of the user based on the orientation sensed by the sensing assembly.

8. The system of claim 1, wherein the sensor portion includes lights that provide visual feedback to the user regarding posture or movement of the user based on the orientation sensed by the sensing assembly.

9. A method of monitoring a posture or a movement of a user seated in a chair comprising the steps of:
providing an electronic tilt sensing, tracking, and reporting system that includes a mount and a sensor portion, the sensor portion including a sensing assembly and a feedback device;
attaching the mount to part of the chair;
securing the sensor portion to the mount;
sensing an orientation of part of the chair relative to the ground on which the chair is supported using the sensing assembly;
determining the posture or movement of the user seated in the chair based on the step of sensing an orientation of part of the chair; and
providing feedback to the user using the feedback device, the feedback regarding the posture or movement.

10. The method of claim 9, wherein the feedback device is a haptic feedback generator, and wherein the step of providing feedback includes providing haptic feedback using the haptic feedback generator.

11. The method of claim 9, wherein the feedback device is lights, and wherein the step of providing feedback includes providing visual feedback using the lights.

12. The method of claim 9, wherein the electronic tilt sensing, tracking, and reporting system further includes fasteners, and wherein the step of securing the sensor portion to the mount is achieved using the fasteners.

13. The method of claim 9, wherein the electronic tilt sensing, tracking, and reporting system further includes magnets, and wherein the step of securing the sensor portion to the mount is achieved using the magnets.

14. An electronic tilt sensing, tracking, and reporting system for monitoring a posture or a movement of a user seated in a chair, the system comprising:
a mount adapted for attachment to the chair; the mount including a first magnet;
a sensor portion including a second magnet, the second magnet interacting with the first magnet to removeably secure the sensor portion to the mount, the sensor portion further including a sensing assembly and a lighting arrangement, the lighting arrangement providing visual feedback to the user regarding posture or movement of the user based on an orientation of part of the chair relative to the ground on which the chair is supported, the orientation being determined by the sensing assembly.

15. The system of claim 14 further comprising an adhesive that attaches the mount to the chair.

16. The system of claim 14, wherein the lighting arrangement displays a first color to indicate that a posture of the user seated in the chair is in a first position and a second color different from the first color to indicate that a posture of the user seated in the chair is in a second position different from the first position.

17. The system of claim 14, wherein the sensor portion further includes a memory, the memory storing information relating to the orientation sensed by the sensing assembly.

18. The system of claim 14, wherein the sensor portion further includes a transmitter and receiver, the transmitter and receiver sending information relating to the orientation sensed by the sensing assembly to an eternal operating device.

19. The system of claim 14 further comprising a rechargeable power supply.

20. The system of claim 19 further comprising a base, the sensor portion being adapted to be engaged with the base to recharge the rechargeable power supply.
